(19) United States
(12) Patent Application Publication
(10) Pub. No.: US 2006/0199549 A1
(43) Pub. Date: Sep. 7, 2006

(54) Common antenna apparatus

(75) Inventors: Jae-Ho Lee, Gumi-si (KR); Do-Hwan Choi, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/320,333

(22) Filed: Dec. 29, 2005

(30) Foreign Application Priority Data
Mar. 2, 2005 (KR) 2005-17276

(51) Int. Cl. H04B 1/46

(52) U.S. Cl. 455/82

(57) ABSTRACT

Disclosed is a common antenna apparatus capable of processing transmission/reception signals of various frequency bands by a single common antenna, by connecting a filter circuit or resonance circuit to a specific position of the single common antenna so as to process the transmission/reception signals. The common antenna apparatus comprises a common antenna having a length sufficient for processing all frequency bands for mobile communication services, and a band extractor located at a specific position of the common antenna in a length direction of the common antenna so as to transmit/receive signals of a specific frequency band, thereby extracting the signals of the specific frequency band.

### PRIORITY

This application claims the benefit under 35 U.S.C. 119(a) of a Korean Patent Application entitled “Common Antenna Apparatus”, filed in the Korean Intellectual Property Office on Mar. 2, 2005 and assigned Serial No. 2005-17276, the entire contents of which are hereby incorporated by reference.

### BACKGROUND OF THE INVENTION

1. Field of the Invention

The present invention relates to a common antenna apparatus capable of processing transmission/reception signals of various frequency bands by one common antenna. More particularly, the present invention relates to a common-antenna apparatus including a filter circuit or resonance circuit connected to a specific position of a common antenna so as to process transmission/reception signals with desired frequency bands.

2. Description of the Related Art

Recently, with the development of mobile communication systems, various communication schemes including a code division multiple access (CDMA) scheme and a time division multiple access (TDMA) scheme have been provided and used. The CDMA widely used in the Americas employs a synchronous scheme capable of allowing a base transceiver station (BTS) and a mobile communication terminal to simultaneously receive information. The CDMA schemes comprise a CDMA scheme for providing services in a band of 850 MHz, and a PCS scheme for providing services in a band of 1.9 GHz. Meanwhile, the TDMA scheme widely used in Europe is an asynchronous scheme, in which information receptions between a base transceiver station and a mobile communication terminal are achieved in sequence. The TDMA schemes comprise a GSM scheme for providing services in a band of 900 MHz, and a Digital Cellular System (DCS) scheme for providing service in a band of 1.8 GHz. That is, CDMA/PCS and GSM/DCS mobile communication systems provide services by using different frequency bands, in other words, 850 MHz/1.9 GHz and 900 MHz/1.8 GHz, respectively. A mobile communication terminal to use a desired mobile communication system comprises an antenna and a duplexer capable of transmitting/receiving signals of a frequency band used in the desired mobile communication system, thereby receiving mobile communication services.

In order to enable one mobile communication terminal to receive services from multiple mobile communication systems, the mobile communication terminal must separately comprise each antenna to transmit/receive signals of a frequency band used in each of the multiple mobile communication systems. For example, in order to realize a particular mobile communication terminal capable of making communication with all base transceiver stations in CDMA, personal communications service (PCS) and GSM systems, the particular mobile communication terminal must comprise a CDMA antenna, a PCS antenna and a GSM antenna which can transmit/receive signals of the CDMA frequency band (850 MHz), the PCS frequency band (1.9 GHz) and the GSM frequency band, respectively. In this case, the particular mobile communication terminal selects a desired system through switching and receives service from the selected system.

FIG. 1 is a block diagram illustrating a conventional configuration of mobile communication terminal which can be used in all the CDMA, PCS and GSM mobile communication systems. The mobile communication terminal shown in FIG. 1 comprises a PCS signal reception unit 105, a GSM signal reception unit 125, a CDMA signal reception unit 145, a switching unit 160 and antennas 100, 120 and 140, in which FIG. 1 shows minimum components for convenience of description. Although PCS, CDMA and GSM signal transmission units for transmitting radio-frequency signals to the base transceiver stations, it goes without saying that radio-frequency transmission signals can be transmitted to the base transceiver stations through the PCS, CDMA or GSM antenna 100, 120 and 14. Also, although FIG. 1 shows the GSM antenna for the TDMA scheme together with the CDMA and PCS antennas for the CDMA scheme to illustrate mobile communication terminals capable of receiving various mobile communication services, they are for illustrative purposes only.

The PCS signal reception unit 105 comprises a PCS duplexer 102, a low-noise amplifier 104, a band-pass filter 106, a frequency synthesizer 150 and a mixer 108. The PCS duplexer 102 distinguishes the transmission signal transmitted through the PCS antenna 100 from the reception signal received through the PCS antenna 100 which has characteristics of allowing only signals adaptable for the use frequency band (1.9 GHz) of the PCS system to pass therethrough, from among a plurality of radio-frequency signals in the field. The low-noise amplifier 104 amplifies a small signal passing through the PCS duplexer 102. The band-pass filter 106 allows only signals of a reception frequency band to pass through the band-pass filter 106, from among signals amplified by the low-noise amplifier 104. The frequency synthesizer 150 functions to find a channel. The mixer 108 converts a radio-frequency signal input through the PCS antenna 100 into an intermediate-frequency (IF) signal. Similarly, both the GSM signal reception unit 125 and CDMA signal reception unit 145 comprises components similar to those included in the PCS signal reception unit 105, so as to have the similar function as that of the PCS signal reception unit 105.

The switching unit 160 receives a selection signal for a service desired by the mobile communication terminal, and performs a switching operation to receive signals of the desired service. For example, in a specific area to which CDMA and PCS services are simultaneously provided, when the switching unit 160 receives a selection signal for PCS use from the user, the switching unit 160 is controlled to select a PCS signal received from the PCS signal reception unit 105 and to transfer the selected PCS signal to a PCS signal processing module. Also, in a case in which the user takes a mobile communication terminal, which has been used for the CDMA service in the Americas, to Europe, when the user switches GSM selection to receive the GSM service, the switching unit 160 changes its switching state from the CDMA signal reception unit 125 to the GSM signal reception unit 145 and transfers a received GSM signal to a GSM signal processing module. It goes without saying that these functions require the assumption that the mobile communication terminal comprises all modules for processing signals provided from every mobile communication system.

However, the conventional mobile communication terminal must separately comprise a plurality of antennas in order to receive services provided from every mobile communication systems as described above, resulting in increasing the manufacturing cost thereof and degrading the external appearance thereof. That is, in order to receive services provided from multiple systems different from each other, the mobile communication terminal must separately comprise a plurality of antennas having different lengths, thereby having many disadvantages in view of cost and external appearance. In addition, the adjacent antennas cause interference between them, which makes it difficult to receive a stable mobile communication service.

### SUMMARY OF THE INVENTION

Accordingly, exemplary embodiments of the present invention address the above-mentioned problems, and an object of the present invention is to provide a mobile communication terminal having one antenna, which can operate in multiple mobile communication systems.

Another object of the present invention is to provide an antenna apparatus which can selectively transmit/receive signals of various mobile communication systems, which are transmitted/received through a single antenna, by selecting operational frequency bands of the signals.

To accomplish these objects, in accordance with one aspect of the present invention, a common antenna apparatus is provided. The common antenna apparatus comprises a common antenna having a length sufficient for processing all frequency bands for mobile communication services, and a band extractor located at a specific position of the common antenna in a length direction of the common antenna so as to transmit/receive signals of a specific frequency band, thereby extracting the signals of the specific frequency band.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a conventional configuration of mobile communication terminal comprising a plurality of separate antennas so that the mobile communication terminal may be used in all the code division multiple access (CDMA), personal communications service (PCS) and Global System for Mobile communications (GSM) mobile communication systems;

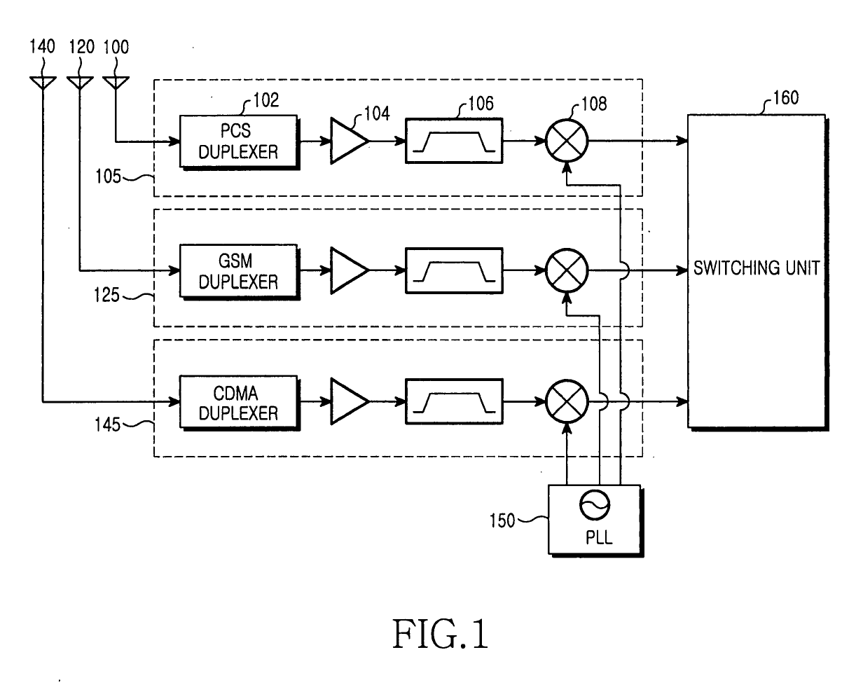

FIG. 2 is a block diagram illustrating a configuration of a transmission/reception processing apparatus of a mobile communication terminal comprising a common antenna according to an exemplary embodiment of the present invention;

FIG. 3 is a diagram illustrating a common antenna apparatus which comprises filter circuits to serve as band extractors according to an exemplary embodiment of the present invention; and

FIG. 4 is a diagram illustrating a common antenna apparatus which comprises serial resonance circuits to serve as band extractors according to an exemplary embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments according to the present invention will be described with reference to the accompanying drawings. In the following description of the present invention, a detailed description of known functions and configurations incorporated herein will be omitted for clarity and conciseness. In addition, the terminology used in the description is defined in consideration of the function of corresponding components used in the present invention and may be varied according to users' practices. Accordingly, the definition should be interpreted based on the overall content disclosed in the description.

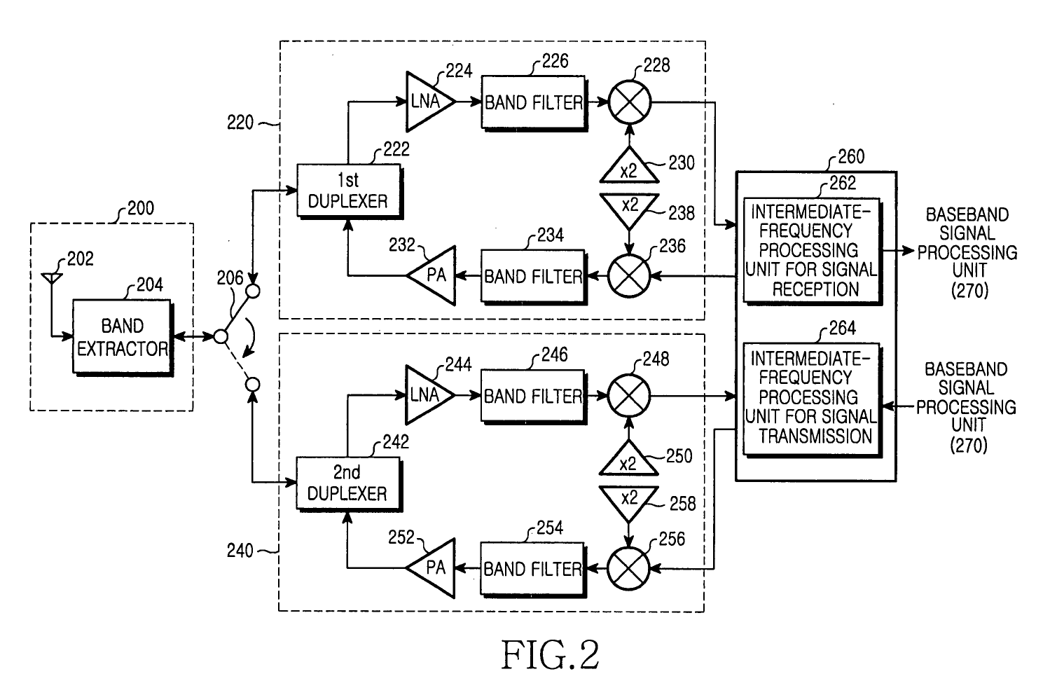

FIG. 2 is a block diagram illustrating the configuration of a transmission/reception processing apparatus of a mobile communication terminal to which a common antenna according to an exemplary embodiment of the present invention is applied. According to an exemplary implementation of the configuration of a common antenna, FIG. 2 does not show the entire configuration of the mobile communication terminal, but shows transmission/reception units connected to the common antenna and an intermediate-frequency signal processing unit.

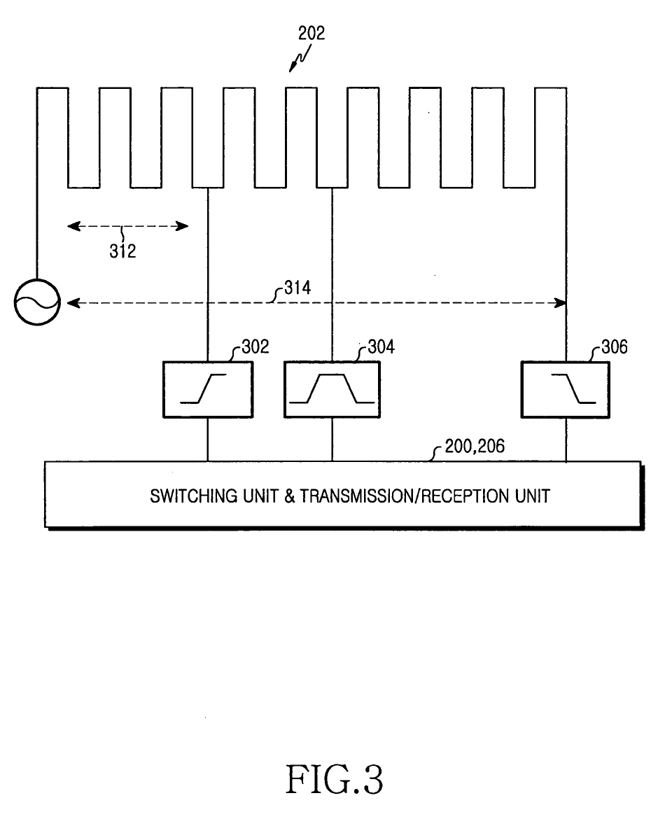

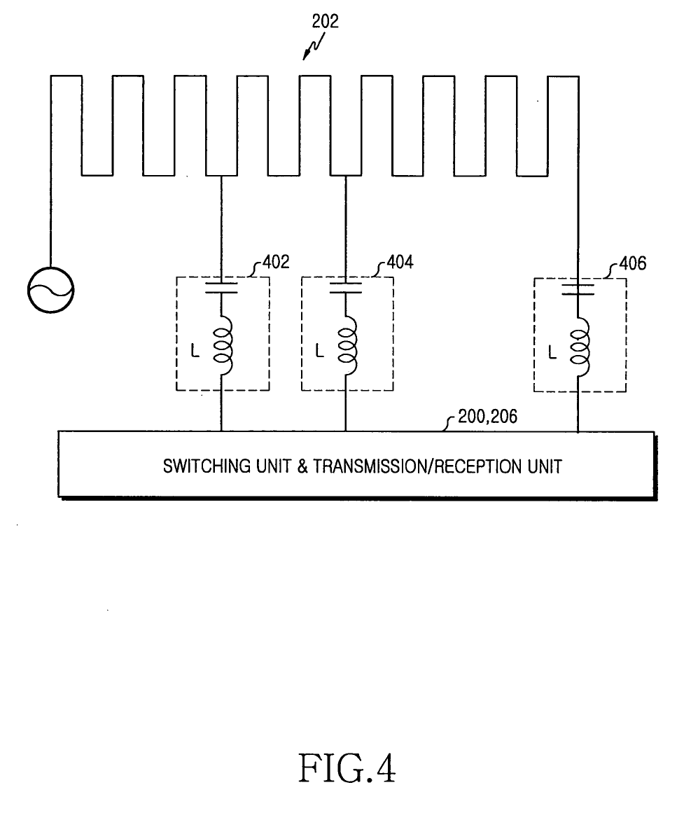

The transmission/reception processing apparatus of the mobile communication terminal comprises a common antenna apparatus 200, a switching unit 206, a first transmission/reception unit 220, a second transmission/reception unit 240, and an intermediate-frequency signal processing unit 260. The common antenna apparatus 200 comprises a common antenna 202 and a band extractor 204. The common antenna 202 is a single element antenna which can transmit/receive signals through the frequency bands of code division multiple access (CDMA), personal communications service (PCS), Global System for Mobile communications (GSM), Digital Cellular System (DCS) systems, and so on. The band extractor 204 comprises a filter circuit or a resonance circuit so as to enable the common antenna 202 to transmit/receive signals of the frequency bands for CDMA, PCS, GSM, DCS systems, and so on, which will be described in detail later with reference to FIGS. 3 and 4.

The switching unit 206 performs a switching operation according to mobile communication services to be provided. For example, the switching unit 206 is switched to the first transmission/reception unit 220 when reception of a PCS service through the mobile communication terminal is desired, and switching unit 206 is switched to the second transmission/reception unit 240 when reception of a CDMA service is desired, thereby transmitting a signal received through the common antenna 202 to a proper transmission/reception unit.

The first and second transmission/reception units 220 and 240 are modules which are tuned to frequency bands for services desired to be provided through the mobile communication terminal in order to perform transmission/reception processing. For example, if the first and second transmission/reception units 220 and 240 are configured to serve as PCS and CDMA transmission/reception units, respectively, the first transmission/reception unit 220 is tuned to 1.9 GHz which is the PCS frequency band to process transmission/reception signals, and the second transmission/reception unit 240 is tuned to 850 MHz which is the CDMA frequency band to process transmission/reception signals. Similarly, if the first and second transmission/reception units 220 and 240 are configured to serve as DCS and GSM transmission/reception units, respectively, the first transmission/reception unit 220 is tuned to 1.8 GHz which is the DCS frequency band to process transmission/reception signals, and the second transmission/reception unit 240 is tuned to 900 MHz which is the GSM frequency band to process transmission/reception signals. That is, each of the first and second transmission/reception units 220 and 240 may be configured to serve as any one of the transmission/reception units for the various mobile communication services.

The intermediate-frequency signal processing unit 260 generates an intermediate frequency to be used in a radio signal processing unit of the mobile communication terminal, and processes signals transmitted/received from/to the first and second transmission/reception units 220 and 240.

Hereinafter, the operations of components including the intermediate-frequency signal processing unit 260 will be schematically described with respect to a mobile communication terminal for CDMA service in which the first and second transmission/reception units 220 and 240 are configured as PCS and CDMA transmission/reception units, respectively (an artisan having ordinary skill in the art will appreciate that the following description may be similarly applied to a mobile communication terminal for Time Division Multiple Access (TDMA) service in which the first and second transmission/reception units 220 and 240 are configured as DCS and GSM transmission/reception units, respectively).

First, when a PCS mode is selected by the user, received signals of various frequency bands (850 MHz for CDMA, 1.9 GHz for PCS, 900 MHz for GSM and 1.8 GHz for DCS) received through the common antenna 202 are filtered by the band extractor 204, and are transmitted to a first duplexer 222 of the first transmission/reception unit 220 through the switching unit 206. The first duplexer 222 extracts a signal of the 1.8 GHz band, which is the frequency band for the PCS, from among the received signals, and inputs the extracted signal to the low-noise amplifier 224. The low-noise amplifier 224 low-noise-amplifies and transmits its received signal to a band filter 226. Then, the received signal is filtered by the band filter 226 having a baseband of 1840 to 1870 MHz, and is transmitted to a reception mixer 228. The reception mixer 228 mixes its received signal with a local oscillation signal, thereby converting its received signal to an intermediate-frequency signal. Herein, the local oscillation signal is generated by multiplying an oscillation signal ‘VCO’ by two in a multiplier 230. The local oscillation signal output from the multiplier 230 has a frequency of 1629.62 to 1659.62 MHz.

The reception mixer 228 mixes a reception signal having a frequency of 1840 to 1870 MHz with the local oscillation signal having a frequency of 1629.62 to 1659.62 MHz, and thus outputs an intermediate-frequency signal having a frequency of 210.38 MHz to the intermediate-frequency signal processing unit 260. The intermediate-frequency signal input to the intermediate-frequency signal processing unit 260 is subjected to a filtering and automatic gain control process through an intermediate-frequency processing unit 262 used for signal reception, thereby being converted into an analog signal to be output to a baseband signal processing unit 270.

Meanwhile, the operation of transmitting an intermediate-frequency signal is performed according to the reverse order of the above-mentioned reception operation. In transmission operation, an intermediate-frequency processing unit 264 used for signal transmission converts an analog signal of a baseband band received from the baseband signal processing unit 270 into a transmission signal having an intermediate-frequency. In addition, the intermediate-frequency processing unit 264 used for signal transmission automatic-power-amplifies the converted transmission intermediate-frequency signal processing, thereby outputting an intermediate-frequency signal having a frequency of 120.38 MHz to a transmission mixer 236 included in the PCS transmission/reception unit 220. The intermediate-frequency signal input to the transmission mixer 236 is mixed with a local oscillation signal to be converted into a transmission signal. Herein, the local oscillation signal is generated by multiplying an oscillation signal ‘VCO’ by two in a multiplier 238. The transmission mixer 236 mixes the transmission signal having an intermediate frequency of 120.38 MHz with the local oscillation signal having a frequency of 1629.62 to 1659.62 MHz, and thus outputs a transmission signal having a frequency of 1750 to 1780 MHz. The output transmission signal is filtered through a band filter 234 having a passband of 1750 to 1780 MHz, and is then output to a power amplifier 232. Then, the transmission signal is power-amplified by the power amplifier 232, and is then transmitted to the first duplexer 222. The transmission signal transmitted to the first duplexer 222 is transferred to the common antenna 202 via the switching unit 206 and band extractor 204, so that the transmission signal based on the PCS mode is emitted through the common antenna 202.

When the user selects a CDMA mode, the mobile communication terminal is tuned to an 850 MHz band for CDMA service through the second transmission/reception unit 240 configured to serve as a CDMA transmission/reception unit, comprises a second duplexer 242, low noise amplifier 244, band filters 246 and 254, mixers 248 and 256, multiplexers 250 and 258, power amplifier 252, and operates in the similar way as described with reference to the first transmission/reception unit 220.

Meanwhile, the common antenna apparatus 200 comprises the common antenna 202 and band extractor 204. The band extractor 204 may comprise a filter circuit or resonance circuit so that the common antenna 202 may transmit/receive signals of the frequency bands for the CDMA, PCS, GSM and DCS services. A band extractor including a filter circuit is shown in FIG. 3, and a band extractor including a resonance circuit is shown in FIG. 4.

FIG. 3 is a diagram illustrating a common antenna apparatus which comprises a filter circuit to serve as a band extractor in order to process the signals of multiple frequency bands according to an exemplary embodiment of the present invention.

In general, an antenna is an element device to actually transmit/receive radio waves and is made from a good conductor. In addition, an antenna is designed such that it transmits/receives a signal by resonating at the wavelength ‘λ’ of the signal when the length of the antenna corresponds to an integer times of a half wavelength ‘λ/2’ of the signal. Therefore, antennas are designed to have different lengths depending on usable frequency bands of the mobile communication services. For example, since an antenna exclusively used for the CDMA transmits/receives signals at the 850 MHz band, the CDMA antenna must be longer than an antenna exclusively used for the PCS. This is because the PCS mobile communication service is provided in the 1.9 GHz band which is a higher frequency than the CDMA mobile communication service. Consequently, as a usable frequency is higher, its corresponding wavelength becomes shorter, and the length of the antenna becomes shorter in proportion to wavelength. For example, since ‘Wavelengh(λ)=Velocity (v)/Frequency(f)’, when the transmission velocity ‘v’ of a frequency signal is ‘3×10⁸’ and the frequency ‘f’ is 1.9 GHz for the PCS, the wavelength ‘λ’ becomes approximately 0.25 m. Thus, a required antenna length is a half of 0.25 m, that is, 12.5 cm. Similarly, when the above calculation method is employed for the CDMA service provided at 850 MHz, required antenna length becomes approximately 16.6 cm. When viewed from the exterior, the mobile communication terminal is seen as if it has no antenna or has an antenna having a very short length because the antenna is fabricated in the form of a foldable antenna or an internal antenna, or the antennae is embodied using ‘wavelength/4’ information when the mobile communication terminal is fabricated.

As described above, different mobile communication services require to use of antennas of different lengths. However, according to the common antenna of an exemplary of the present invention, the signals of all bands for CDMA (850 MHz), PCS (1.9 GHz), GSM (900 MHz) and DCS (1.8 GHz) services can be received by a single common antenna. To this end, as shown in FIG. 3, the common antenna 202 comprises a low pass filter (LPF) 306, a baseband pass filter (BPF) 304 and a high pass filter (HPF) 302 at specific positions along the length direction thereof, thereby passing and processing signals of specific frequency bands, respectively.

For example, since the length of an antenna to transmit/receive PCS signals of the 1.9 GHz band is 12.5 cm as calculated above, a predetermined filter 302 capable of extracting signals of the 1.9 GHz band is disposed at the position corresponding to the antenna length 312 of 12.5 cm. In this case, the predetermined filter 302 may comprise a high pass filter which passes all signals of more than or equal to a predetermined band in order to transmit/receive signals of more than or equal to the 1.9 GHz band. Similarly, since the length of an antenna to transmit/receive CDMA signals of the 850 MHz band is 16.6 cm as calculated above, a predetermined filter 306 is disposed at the position corresponding to the antenna length 314 of 12.5 cm. In this case, the predetermined filter 306 may comprise a low pass filter which passes all signals of less than or equal to a predetermined band in order to transmit/receive signals of less than or equal to the 850 MHz band.

In addition to the high pass filter 302 and the low pass filter 306 disposed in specific positions along the length direction of the common antenna in order to transmit/receive PCS and CDMA signals, a baseband pass filter (BPF) 304 may be disposed at a specific position of the common antenna so as to transmit/receive signals of only a desired frequency band. Meanwhile, each of the low pass filter (LPF), baseband pass filter (BPF) and high pass filter (HPF) may be realized by an IC-chip filter, a passive device such as a RLC circuit, or an active device such as an OP amp, and has no restrictions in configuring a band pass filter for each corresponding band.

FIG. 4 is a diagram illustrating a common antenna apparatus which comprises a resonance circuit to serve as a band extractor in order to process the signals of multiple frequency bands according to an exemplary embodiment of the present invention.

FIG. 4 shows a common antenna apparatus including serial resonance circuits as a band extractor, wherein, in the same manner as the band extractor shown in FIG. 3, the serial resonance circuits are disposed in predetermined positions corresponding to the common antenna such that they are positioned at positions corresponding to an integer times of a half wavelength by calculating the wavelength of the use frequency band of each mobile communication service.

The serial resonance circuit transmits/receives signals by resonating with signals received at its position disposed on the common antenna. The serial resonance circuit comprises a L-C serial resonance circuit according to an exemplary embodiment of the present invention. For example, when it is necessary to resonate the L-C serial resonance circuit 402 with the frequency band of the PCS service, an inductor L and a capacitor C of the L-C serial resonance circuit 402 must have predetermined values such that the L-C serial resonance circuit 402 resonates with the 1.9 GHz band used for the PCS service. The values of the inductor L and the capacitor C may be determined by using the resonance frequency formula as shown in Equation 1.

$${f}_{0} = \frac{1}{2 π \sqrt{LC}} \qquad ( 1 )$$

Also, when it is required to resonate with the CDMA frequency band, the L-C serial resonance circuit 406 is designed to resonate with the 850 MHz band used for the CDMA service by controlling the values of the inductor (L) and capacitor (C) based on equation 1. Similarly, in order to transmit/receive signals of a frequency band used for a specific mobile communication service, a L-C serial resonance circuit 404 may be disposed at a proper position so as to transmit/receive signals of the desired frequency band.

As described above, exemplary embodiments of the present invention provide a common antenna capable of processing signals of frequency bands for various mobile communication services, so that the external appearance of the mobile communication terminal is improved, the volume thereof becomes smaller, and its manufacturing cost is reduced. In addition, signals according to multiple frequency bands are processed not by multiple antennas but by the single common antenna, interference between antennas can be prevented.

While the present invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A common antenna apparatus comprising:
a common antenna having a length sufficient for processing all frequency bands for mobile communication services; and
a band extractor located at a specific position of the common antenna in a length direction of the common antenna to transmit/receive signals of one frequency band of all bands, thereby extracting the signals of the one frequency band.

2. The common antenna apparatus as claimed in claim 1, wherein the frequency bands for the mobile communication services comprises at least one of a frequency band for a code division multiple access service, a frequency band for a time division multiple access service and a frequency band for a Global Positioning System (GPS) service.

3. The common antenna apparatus as claimed in claim 1, wherein the specific position in the length direction of the common antenna corresponds to an integer times of a wavelength of a frequency band of signals to be transmitted/received.

4. The common antenna apparatus as claimed in claim 1, wherein the band extractor comprises a filter allowing signals having a specific frequency band to pass therethrough.

5. The common antenna apparatus as claimed in claim 4, wherein the filter comprises at least one of a low pass filter (LPF), a baseband pass filter (BPF) and a high pass filter (HPF).

6. The common antenna apparatus as claimed in claim 1, wherein the band extractor comprises a serial resonance circuit which resonates with a specific frequency band.

7. The common antenna apparatus as claimed in claim 6, wherein the serial resonance circuit comprises a L-C serial resonance circuit.

8. The common antenna apparatus as claimed in claim 6, wherein, in the L-C serial resonance circuit, values of the ‘L’ and ‘C’ elements are determined such that the L-C serial resonance circuit resonates with a frequency band corresponding to a position thereof related to the common antenna.
